(19) United States
(12) Patent Application Publication
(10) Pub. No.: US 2024/0303848 A1
(43) Pub. Date: Sep. 12, 2024

(54) ELECTRONIC DEVICE AND METHOD FOR DETERMINING HUMAN HEIGHT USING NEURAL NETWORKS

(71) Applicant: N.V. Nutricia, Zoetermeer (NL)

(72) Inventors: Agathe Camille Foussat, Singapore (SG); Reyhan Suryaditama, Singapore (SG); Meenakshisundaram Palaniappan, Singapore (SG); Ruben Zado Hekster, Utrecht (NL); Laurens Alexander Drapers, Utrecht (NL)

(73) Assignee: N.V. Nutricia, Zoetermeer (NL)

(21) Appl. No.: 18/607,598

(22) Filed: Mar. 18, 2024

Related U.S. Application Data
(62) Division of application No. PCT/EP2021/075785, filed on Sep. 20, 2021.

(51) Int. Cl. G06T 7/60; G06T 7/70

(52) U.S. Cl. CPC G06T 7/60; G06T 7/70; G06T 2207/20084; G06T 2207/30196

(57) ABSTRACT

Electronic device for estimating a height of a human, the electronic device comprising: a processor configured to: obtain an image including at least a part of a representation of the human and reference information; input the image to a first neural network and obtain as output from the first neural network first information, the first information related to a plurality of keypoints in the body of the human; input the image to a second neural network and obtain as output from the second neural network second information, the second information related to the reference information; and estimate the height of the human based on the first information and the second information; and an output unit configured to output the estimated height.

### FIELD OF THE INVENTION

The present invention relates to an electronic device for estimating the height of a human using neural networks, and for a method performed by the electronic device for estimating the height of the human.

### BACKGROUND ART

Measuring the height of a person has traditionally been done in various ways, the most professional of which included professional equipment which was only available at healthcare providers or pharmacies. More rudimentary techniques included the use of measuring bands, or standing against a wall and making a mark the height of which would be measured. The professional mechanisms are still used nowadays and provide an accurate measurement. They are however available only in specific locations, and are not accessible to everyone at any time. The more rudimentary techniques can be used anywhere but can be inaccurate. In the past years, the development of image processing techniques has allowed for the rise of techniques which analyze images to obtain the height of a person.

However, these techniques require multiple images or a video to be captured. In addition, these techniques require the person to be standing. This becomes specially complicated when an infant's height is to be measured, as not-yet walking infants are not able to stand, and it is difficult that they remain in a specific position.

There is therefore a need for a mechanism to obtain the height of a human, which does not require the human to be standing or to be in a specific position, and which is simple to use anywhere.

### SUMMARY OF THE INVENTION

The present invention aims to overcome at least some of these disadvantages, as it allows to obtain the height of a person in a simple yet accurate manner.

According to the present invention, an electronic device for estimating a height of a human is provided. The electronic device comprises a processor configured to: obtain an image including at least a part of a representation of the human and reference information; input the image to a first neural network and obtain as output from the first neural network first information, the first information related to a plurality of keypoints in the body of the human; input the image to a second neural network and obtain as output from the second neural network second information, the second information related to the reference information; and estimate the height of the human based on the first information and the second information; and the electronic device comprising an output unit configured to output the estimated height.

The electronic device of the present invention has the advantage of allowing to estimate the height of a human in a simple manner by only requiring to capture one image. This is achieved by inputting the one and the same image to two neural networks, wherein the first neural network provides as output information related to the height, more specifically information related to a plurality of keypoints in the body of the human, and the second neural network provides as output information related to the reference information. The two neural networks thus focus each on different aspects or features of the same image. By analysing the same image separately, the height-related information from the first neural network and the reference information from the second neural network can be combined to obtain an estimation of the height of the human. The reference information may also be referred to as calibration information, or physical dimension calibration information.

According to embodiments of the present invention, the second information is information linking the reference information with physical distance information.

According to embodiments of the present invention, the first neural network is configured to segment the at least part of the representation of the human into a plurality of body parts, and to predict the plurality of keypoints in the body of the human based on the plurality of body parts.

According to embodiments of the present invention, the information related to the plurality of keypoints comprises coordinate information about at least part of the plurality of keypoints.

The first neural network is advantageously configured to recognize or detect the representation of the human, or the object in the image representing at least partially the human, and to segment the representation of the body of the human into a plurality of body parts. The first neural network is also configured to predict keypoints based on the body parts, and information related to at least part of the keypoints is the output first information. By segmenting the body into parts and identifying keypoints which correspond to specific points in the body, a skeleton of the body can be drawn, by which the different parts of the body can be identified.

According to embodiments of the present invention, a keypoint corresponds to one of a list comprising face, shoulder, hip, knee, ankle and heel. The first information, output from the first neural network, comprises thus information related to coordinates in the image of specific and key parts of the body which are necessary to determine the height.

According to embodiments of the present invention, the first neural network is configured to identify a predefined number of keypoints, and if at least one keypoint is not identified by the first neural network with at least 50% of detection confidence and at least 50% of visibility, the processor is configured to generate a notification indicating that the height cannot be estimated, and the output unit is configured to output the notification. For example, according to an embodiment, if the following are the predefined keypoints that need to be predicted, all keypoints need to have at least a 50% of visibility: right heel—left heel, right ankle—left ankle, right hip—left hip, right knee—left-knee, right shoulder—left shoulder. Detection confidence may refer to the confidence score (0,1) for the detection to be considered successful, and it may be a parameter passed to the first neural network by the electronic device. The visibility may be included in the first output information, together with the coordinate information for each keypoint, indicating the likelihood of the keypoint being visible.

According to embodiments of the present invention, the first neural network is a convolutional neural network for human pose estimation implemented with a BlazePose neural network, for which the prediction of the keypoints has been parametrized using mediapipe pose solution application program interface, and wherein an output of the BlazePose/mediapipe pose solution application interface is passed through a Broyden, Fletcher, Goldfarb, and Shanno, BFGS, optimization algorithm. BlazePose is a lightweight convolutional neural network architecture with good performance for real-time inference on mobile devices.

According to embodiments of the present invention, the processor is further configured to use the first information to compute Euclidean distances between coordinates of the at least part of the plurality of keypoints on the image to calculate a pixel length of the representation of the human in the image. By using the first information output from the first neural network, more specifically the coordinate information of the plurality of keypoints, and if the visibility information corresponding to each coordinate information is at least 50%, the processor may be configured to obtain the Euclidean distance between consecutive keypoints, (for example between heel and ankle, between ankle and knee, between knee and hip, between hip and shoulder, between shoulder and top of head) and add the obtained distances with each other in order to obtain the height of the human. For example, according to an embodiment, the processor may be configured to calculate the distance in pixels between the coordinates for the left ankle and the left knee, the distance in pixels between the coordinates for the left knee and the left hip, the coordinates between the left hip and the left shoulder, and the coordinates between the left shoulder and the top of the head.

According to embodiments of the present invention, the reference information includes an object of a known predetermined size, such as an object of the size of a credit card. By including in the image an object of a known size (width by height), the second neural network can recognize the object and associate it with the known size. The known size can be used to transform the height information obtained from processing the first information output from the first neural network into the final height estimation.

According to embodiments of the present invention, the second neural network is configured to find contours of the object, recognize the object, and obtain the predetermined size of the object, and wherein the second information comprises information related to the physical size of the object. In other words, based on the known predefined size of the object, the second neural network can output pixel to metric ratio information, and the processor may be configured to transform the height information obtained using the first information output from the first neural network into physical height information. For example, the processor may be configured to transform the pixel height information into physical height information.

According to embodiments of the present invention, the second neural network is configured to output a notification if the object cannot be recognized, and the output unit is configured to output the notification. This notification may indicate that the height cannot be estimated, and/or the notification can request the user to provide the predetermined object so that it is correctly visible, that is, so that it can be recognized by the second neural network.

According to embodiments of the present invention, the second neural network is formed from a convolutional neural network U-Net with EfficientNet-b0 backbone. The U-net is a convolutional neural network architecture for fast and precise segmentation of images. The EfficienNet backbone provides high accuracy and good efficiency in object recognition.

According to embodiments of the present invention, the electronic device further comprises an image capturing unit configured to capture the image. The image can thus be obtained by the processor by different means. It may be directly captured by an image capturing unit of the electronic device, such as a camera, or it may receive the image from other means such as by downloading it from the internet or by receiving it from an external device.

According to embodiments of the present invention, the processor is configured to perform the operations of at least one of the first and second neural networks. At least one of the first and second neural networks may thus be implemented by the processor of the electronic device. This has the advantage that a connection with an external server may be avoided and the estimation of the height may be performed locally by the electronic device.

According to the present invention, a method of obtaining the height of a human using the electronic device described above is provided. The method comprises: obtaining an image including at least a part of a representation of the human and reference information; inputting the image to a first neural network, and obtaining as output from the first neural network first information, the first information related to a plurality of keypoints in the body of the human; inputting the image to a second neural network and obtaining as output from the second neural network second information, the second information related to the reference information; estimating the height of the human based on the first information and the second information, and outputting the estimated height.

According to embodiments of the present invention, the operations of the first and second neural networks are performed by the processor of the electronic device.

According to embodiments of the present invention, the operations of the first and second neural networks are performed by a server in communication with the electronic device, and wherein the method further comprises the electronic device transmitting the image to the server and receiving the first information and the second information from the server.

### BRIEF DESCRIPTION OF THE DRAWINGS

The present invention will be discussed in more detail below, with reference to the attached drawings, in which:

FIG. 1 depicts an overview of the system according to embodiments of the present invention;

FIG. 2 illustrates a flowchart depicting the operations of the neural networks according to embodiments of the present invention;

FIG. 3 shows a flowchart depicting a method according to embodiments of the present invention;

FIGS. 4a-4f show screenshots of the electronic device for different human postures and reference information according to embodiments of the present invention.

### DESCRIPTION OF EMBODIMENTS

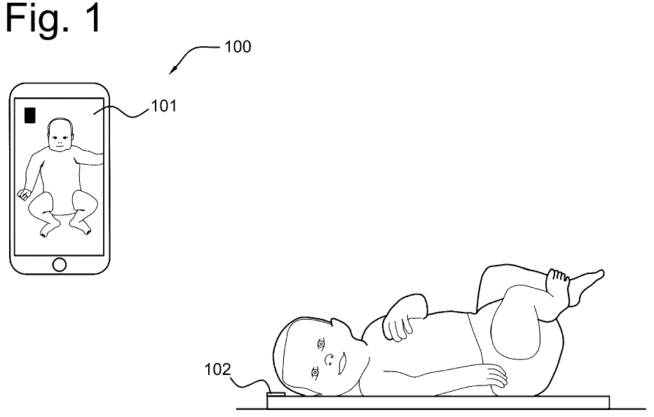

FIG. 1 depicts an overview of the system according to embodiments of the present invention. As seen in FIG. 1, the electronic device 100 comprises an output unit 101, which in this case corresponds to a display such as a touch display. The output unit may additionally or instead comprise a speaker. The electronic device may also comprise an input unit, which can also correspond to the touch display or to a separate input unit such as a keyboard. The electronic device also comprises a processor or processing unit that is configured to control the overall operation of the electronic device. The electronic device 100 of FIG. 1 also comprises an image capturing unit (now shown in the figure), for example a camera unit, configured to capture an image which will be used to estimate the height. However, the image may also be obtained by the processor by other means different from the image capturing unit, as the electronic device may also include a communication unit and the image may be downloaded or received from an external device, and the electronic device may also include a memory or storage unit where the image may be stored.

The electronic device 100 may comprise a software application installed therein that when executed by the processor allows to perform the steps of the method of the present invention. For example, FIG. 1 shows a screenshot of the display of the electronic device while the application is being executed, and the electronic device 100 has captured or will capture an image of the human which will be used to determine the height estimation.

In the embodiment of FIG. 1, and throughout the following description, it will be considered that the human is an infant, however it is to be understood that the present invention can be modified to be applied for the estimation of the height of a person of any height. An infant is given as an example, in order to show that even in cases where the human is not standing and not in a straight position, as is normal the case with infants, the present invention is able to estimate the height. Also throughout the description, height and length of the human or infant may be used interchangeably.

FIG. 1 shows that the image which has or will be captured includes reference information, in this case in the form of an object 102 with a credit card size. The present invention requires that reference information is present in the image in order to be able to, using only one image, convert the pixel height that can be inferred from the analysis of the body parts with the first neural network, into actual (physical) height information. Using an object of a known size, which a user will likely have at hand at any time, allows to provide the reference information in a simple and accurate way. Using an object of the size of a credit card allows to use any kind of card that has said size, which includes IDs, insurance cards, fidelity cards of stores, driving licenses, public transport cards, and many other cards which users will likely carry with them at all times. The reference information may also be referred to as calibration information, or physical dimension calibration information. Other types of suitable reference information may also be used, as long as they can serve as a reference to link the pixel distance with the physical distance.

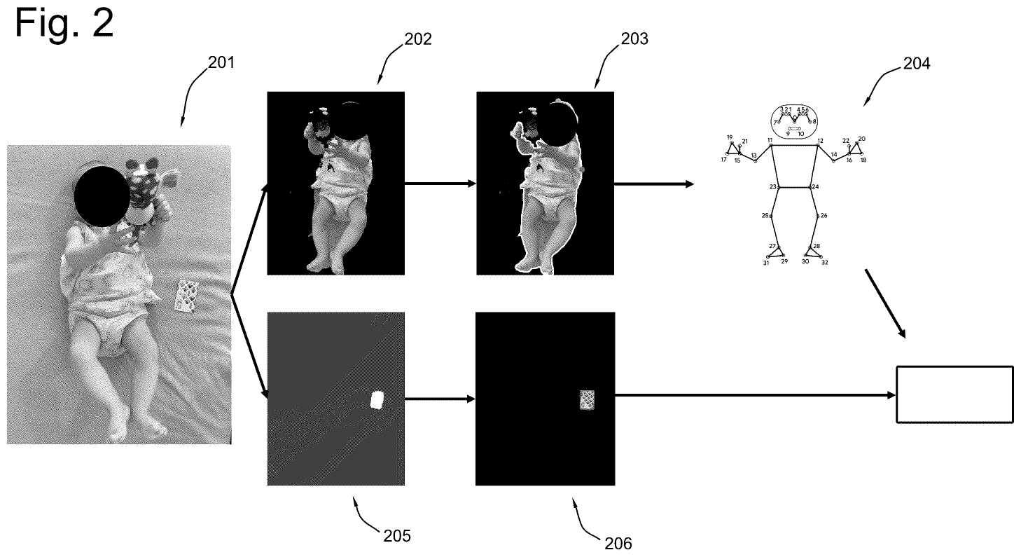

FIG. 2 illustrates a flowchart depicting the operations of the neural networks according to embodiments of the present invention.

As seen in FIG. 1 above, the processor is configured to obtain an image. The image may comprise at least a part of a representation of a human, and also reference information. The processor is then configured to input the image to two neural networks, which will perform a different analysis of the image.

The first neural network may be configured to determine the pose of the human. It may take as input an image 201 which can be a color (RGB) image, and may be configured to recognize 202 the region of the image in which the representation of the human is present, segment 203 the body of the representation of the human in multiple body parts, and predict 204 coordinates of keypoints of the body based on the segmented parts. Each keypoint may correspond to one of a list comprising face, shoulder, hip, knee, ankle and heel. In order to be able to predict the keypoints, the first neural network must know what to look for in the image, that is, it must be trained. The first network according to embodiments of the present invention is a convolutional neural network (CNN). A CNN is a neural network that is trained on a large amount of images from an image database, such as the ImageNet database. A CNN is made up to a certain number of layers and is taught the feature representations for a wide range of images. The CNN can be implemented using several libraries, such as the Tensorflow library and the Keras library along with image processing libraries such as OpenCV and can also be implemented into programming languages such as Python, C, C++, and the like and may run on a single or multiple processors or processor cores, or on a parallel computing platform such as CUDA.

The training is performed by inputting training images to the CNN. The training images can be stock images, test images and even simulated images. In order to obtain classification accuracies of over 90%, it is preferred to use many images for training, ranging from 5,000 to 10,000 images, and more preferably 8,000 to 9,000 images. The training images may include images created with image augmentation, by performing transformations like rotating, cropping, zooming, colouring based methods. For example, for training a neural network, various types of data augmentation implemented are horizontal flip, perspective transforms, brightness/contrast/colors manipulations, image blurring and sharpening, Gaussian noise. These operations increase the robustness of the CNN. The convolutional layers of the CNN extract image features that the last learnable layer and the final classification layer use to classify the input image. These two layers contain information on how to combine the features that the CNN extracts into class probabilities and predicted labels.

In most CNNs, the last layer with learnable weights is a fully connected layer, which multiplies the input by the learned weights. During the training, this layer is replaced with a new fully connected layer with the number of outputs equal to the number of classes in the new data set. By increasing the learning rate of the layer, it is possible to learn faster in the new layer than in the transferred layers.

Once trained, the CNN is able to analyse the input image. The CNN takes an image as an input, and may require the input image to be of a specific size, for example a size of 224 by 224 pixels. If the input image differs from the allowed input size, then a pre-processing step may be performed whereby the image is resized (by either upscaling or downscaling), or cropped in order to fit the required input size. Other pre-processing that can be performed is color calibration and/or image normalization.

In the case of the first neural network of embodiments of the present invention, the first neural network may also be neural network which is already trained and no additional training may be performed. The first neural network is configured to provide height related information, preferably information related to at least part of the plurality of keypoints. The output provided by the first neural network may include a set of keypoint coordinates along with their respective visibility metric or percentage, for example in the form of a vector.

The first neural network may be a convolutional neural network for human pose estimation implemented with a BlazePose neural network, for which the prediction of the keypoints has been parametrized using mediapipe pose solution application program interface. BlazePose is a lightweight convolutional neural network architecture with good performance for real-time inference on mobile devices. The BlazePose architecture has been described in “BlazePose: On-device Real-time Body Pose tracking”, Valentin Bazarevsky et. al. The BlazePose architecture uses heatmaps and regression to obtain keypoint coordinates. Networks using heatmaps are helpful in determining the parts of a frame where an object appears more prominently (i.e. high exposure areas of the infant's skeleton joints) and regression networks attempt to predict the mean coordinate values by learning a regression function. The architectures also utilize skip-connections between all the stages of network to achieve a balance between high and low-level features. Although developed to be used for applications such as fitness tracking and sign language recognition, the inventors realized that it can be used as part of a mechanism to predict the height of a person. The output of the BlazePose/mediapipe pose solution application interface according to embodiments of the present invention may be passed through a Broyden, Fletcher, Goldfarb, and Shanno, BFGS, optimization (minimization) algorithm. The output of the BlazePose/mediapipe pose estimation API may thus be passed to a BGFS minimizer so that the results can be optimized and the accuracy can be improved, in other words, so that a result can be produced as close as possible to the parent reported length. The advantage is that it reduces error. BGFS minimizer is one of the popular parameter estimator algorithms in machine learning, and can be considered as an algorithm to identify the scalar multiples for various lengths, angles etc. of the keypoints so that the result actual length is closer to the parent reported length.

The training phase for the first neural network including the BFGS algorithm was implemented in embodiments of the present invention with between 200 and 400 images, for example 249.

The first neural network may be configured to recognize the representation of the human body in the image separate it from the rest of the image, segment the body in parts, and identify a predefined number of keypoints, and if at least one keypoint has less than 50% detection confidence and at least 50% visibility, the processor may be configured to generate a notification indicating that the height cannot be estimated, and the output unit is configured to output the notification. Detection confidence may refer to the confidence score (0,1) for the detection to be considered successful, and it may be a parameter passed to the first neural network by the electronic device. The visibility may be included in the first output information, together with the coordinate information for each keypoint, indicating the likelihood of the keypoint being visible. As long as there is an uncluttered background, there can be other objects in the image and the first neural network will be able to separate the human from the rest of the image. Through guidance, the electronic device according to embodiments of the present invention can also instruct that there are no other humans present in the image. For example, according to an embodiment, the following elements may need to be visible with at least 50% of detection confidence and 50% visibility by the first neural network: right heel—left heel, right ankle—left ankle, right hip—left hip, right knee—left-knee, right shoulder—left-shoulder, top forehead, middle eyes, nose.

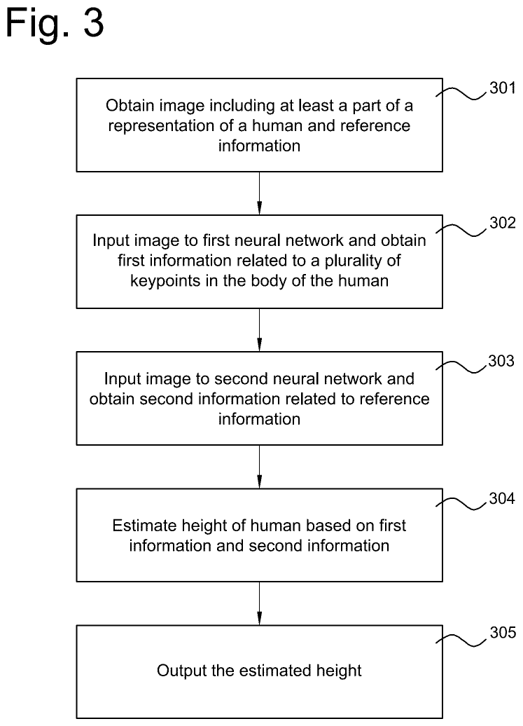

If the first neural network is the BlazePose network, the predefined number of keypoints is 33, as seen in 204 of FIG. 3, which is taken from “BlazePose: On-device Real-time Body Pose tracking”, Valentin Bazarevsky et. al. The predictions of the keypoints by the first neural network are accurate with a frontal face, and no objects/body parts/dress obstructing the view of the keypoints such as face, core body, knees, ankles etc. For example, the accuracy (percentage of correct keypoints detected) of the BlazePose model on a datasets of 1000 images each containing 1-2 people in it of wide variety of human poses may be 79.6%. If for example a dress is obstructing the knees, the keypoints identifying the knees will not be recognized by the first neural network. An example is an oversized full-sleeved sleeping suit, which may not allow to detect the keypoints because of being too large.

The first neural network may output as first information the information related to the identified keypoints. If the first neural network is not able to identify enough keypoints with at least 50% detection confident and with at least 50% of visibility, this will be reflected in the output from the first neural network, which will include a notification. The content of this notification may vary, and may be part of the normal output of the first neural network, that is, a percentage of visibility for each coordinate. If the percentage for a least one coordinate is less than 50%, that may be considered the notification by the processor. The notification may be given in another way, as long as the processor is able to identify that the pose could not be estimated and therefore the height cannot be estimated. The processor will use this information to output, via the output unit, information indicating that the height cannot be estimated, and/or informing the user to capture a new image in which enough keypoints are visible. An example of the output notification may be “Pose estimation not successful”.

According to embodiments of the present invention, when the first neural network identifies all the predefined keypoints with at least 50% of detection confidence and at least 50% of visibility, with the keypoint-related information, the processor is further configured to obtain Euclidean distances between coordinates of a plurality of keypoints on the image to calculate a pixel length of the representation of the human in the image. In other words, the processor may be configured to obtain the Euclidean distance between consecutive keypoints, that is, keypoints which the processor knows belong to consecutive body parts, and add the obtained distances with each other in order to obtain the height in pixels of the human. For example, according to an embodiment, the processor may be configured to calculate the distance in pixels between the coordinates for the left ankle and the left knee, the distance in pixels between the coordinates for the left knee and the left hip, the coordinates between the left hip and the left shoulder, and the coordinates between the left shoulder and the top of the head.

In order to compute the Euclidean distance, the processor may average the output of the first neural network, such that for example distance between the coordinate of the left ankle and the left knee and the distance between the coordinate of the right ankle and the right knee are averaged to produce a unified length. This increases accuracy. In another embodiment, instead of averaging the lengths, the largest of the two could be used, or other suitable method.

However, the height in pixels does not provide complete information, as it is only related to the image, and does not have information about the actual physical height.

In order to solve this, the image 201 is also input to the second neural network. The second neural network according to embodiments of the present invention is also a convolutional neural network, configured (trained) to recognize the reference information. In this embodiment, the reference information includes an object of a known predetermined size, such as an object of the size of a credit card. By including in the image an object of a known size (width by height), the second neural network can recognize the object and associated with the known size. For example the standard size of a credit card is width of 85.6 mm (3.37 inches) and height of 53.98 mm (2.125 inches).

The second neural network may be configured to find 205 contours of the object, recognize 206 the object, and associate the recognized object with a known object of which the size is also known. The second information, output of the second neural network, may comprise information related to the physical size of the object, such as pixel to metric information. Based on the known size of the object, and on the pixel to metric information, the processor may be configured to transform the height information in pixels obtained after processing the output of the first neural network into physical height information.

The second neural network may be formed from a convolutional neural network U-Net with EfficientNet-b0 backbone. The U-net is a convolutional neural network architecture for fast and precise segmentation of images. The EfficienNet backbone provides high accuracy and good efficiency in object recognition. The U-net of embodiments the present invention may have been trained to recognized certain reference information, such as credit card sized objects. Some main drivers like the hard augmentation of the card in the card segmentation algorithm lead to a higher accuracy and thus to a more accurate length prediction of the card.

In order to obtain the second neural network according to embodiments of the present invention, the final layer of the U-Net may have been modified and all the layers within U-Net architecture may have been retrained with own data.

During the training phase, in an embodiment, between 3000 and 4000 images have been used, such as 3698. Techniques such as data augmentation have been used to increase the amount of data and prevent model overfitting. The various data augmentation implemented are horizontal flip, perspective transforms, brightness/contrast/colors manipulations, image blurring and sharpening, Gaussian noise.

Additionally, a synthetic card dataset was created to augment the existing data for the card segmentation second neural network. About 100 cards were manually segmented from the original dataset. From approximately 40 images, the infant images were cropped such that the card was not visible in the image anymore. Then all the manually segmented cards were pasted on the approximately 40 infant backgrounds. In total, 3698 new images were created to train a card segmentation model.

The model was fine-tuned to achieve overall high mean of the Intersection over de Union (mIoU) metric, which shows an accuracy of more than 0.96.

When more than one credit card sized object is in the image, the second neural network may be configured to consider the card with the highest resemblance as in-reference object and the other(s) is/are ignored. Through guidance, the electronic device may be able to instruct parents or users not to have more than one card in the image.

The reference information is required for estimating the height. If the reference information is not properly visible or identifiable, the second neural network will not be able to recognize it and provide the ratio between the pixel distance and the metric distance. The second neural network is configured to output a notification if the object is not correctly recognized, and the output unit is configured to output the notification. This notification may indicate that the height cannot be estimated, and/or the notification can request the user to provide the predetermined object so that it is correctly visible. An example of the notification can be “Card segmentation not successful” or “Card identification not successful”.

FIG. 3 shows a flowchart depicting a method according to embodiments of the present invention. The method of FIG. 3 of obtaining the height of a human (such as an infant) starts in step 301, by obtaining, by the processor of the electronic device, an image including at least a part of a representation of the human and reference information. The image can be obtained by means of an image capturing unit included or connected to the electronic device, or received by the electronic device by another means. It may be obtained from a memory of the electronic device or other storage device in which the memory is stored, it may be obtained through a data communications connection from an external device or cloud, it may be obtained from a camera module of the electronic device which has captured the image, or other suitable way which is apparent for the skilled person.

Step 302 comprises inputting, by the processor, the image to the first neural network, and obtaining as output from the first neural network first information, the first information related to the height of the human, more specifically related to a plurality of keypoints in the body of the human. Step 303 comprises inputting, by the processor, the image to the second neural network and obtaining as output from the second neural network second information, the second information related to the reference information.

Step 304 comprises estimating the height of the human based on the first information and the second information, and step 305 comprises outputting the estimated height. The output may be performed by an output unit of the electronic device.

The operations of the first and second neural networks have been explained above with reference to FIG. 3. The processor of the electronic device may be configured to perform the operations of at least one of the first and second neural networks. This means that at least one of the first or second neural networks will be executed by the processor of the electronic device, and this allows the execution of the height estimation locally at the electronic device, in an offline mode which does not require communication with any external server. This can thus be done without a connection to the internet. The first and second neural networks may have lightweight architectures which further facilitate their execution by electronic devices, such as portable electronic devices like smartphones, tablet computers, or the like. Other portable devices like computers or laptops can be used. Specifically, the BlazePose architecture, which is the architecture of the first neural network according to some embodiments of the present invention, is lightweight and effective for use in portable terminals. It also works faster due to conversion to TensorFlowLite (tflite) format, which means quantization of the weights of the neural network layers. Moreover, the focal loss instead of binary cross entropy as solution's loss function for the second neural network also lead to multiple percentage points in increased accuracy. The loss function used in the second neural network of the present invention may be focal loss or weighted-cross entropy instead of binary cross entropy as the object to be detected in the image is small. In embodiments of the present invention, most of the image comprises background and infant, whereas the card is available only in a few pixels of the image. If the traditional binary cross-entropy was used as loss function, it would mean that one wants the second neural network to be 80-100% confident that the object in the picture is really a card making it difficult to segment them from the picture, and resulting in more error/no result scenario.

Similarly, the U-Net architecture of embodiments of the present invention is lightweight and can be implemented in portable devices.

In embodiments of the present invention, and also for those electronic devices with little processing power, it is possible that the operations of at least one of the first or second neural network are performed by an external server in communication with the electronic device, for example in communication through cloud computing or the internet. The electronic device, or a communication unit of the electronic device, may in this case be configured to transmit the image to the server, and receive from the server the first information and second information from the first and second neural networks, respectively.

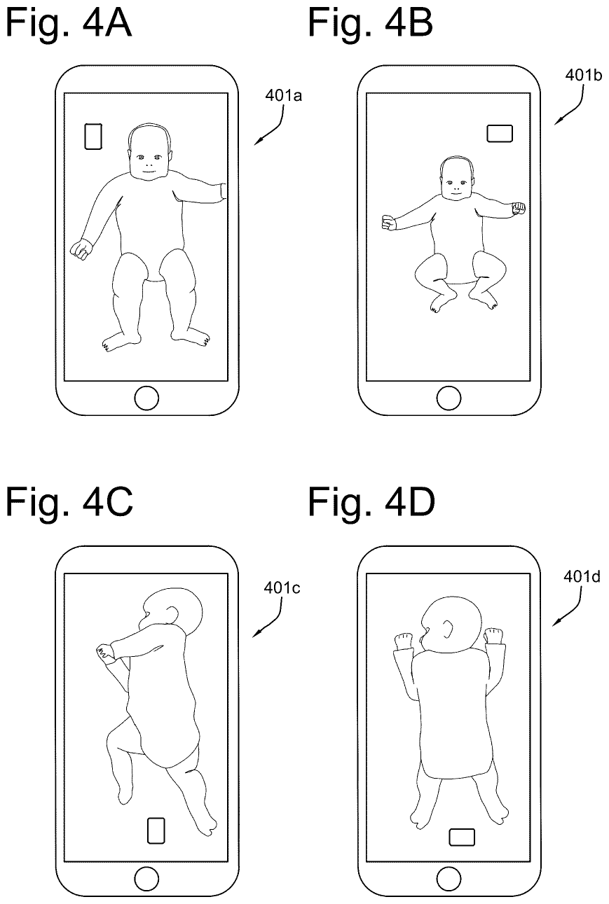

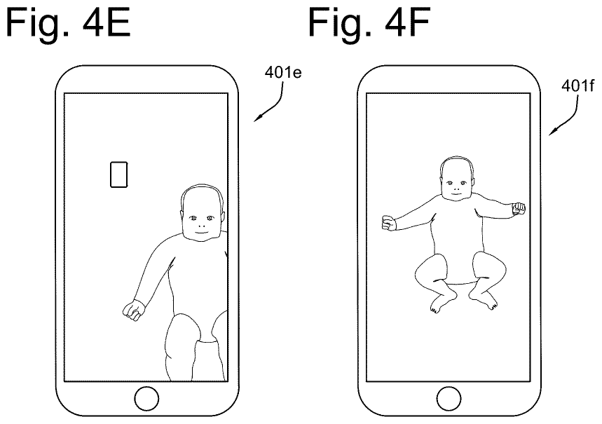

FIGS. 4a-4f show screenshots of the electronic device for different human postures and reference information according to embodiments of the present invention. FIGS. 4a-4f represent embodiments showing examples of postures of the human and reference information which would or would not result in the height being correctly estimated. FIG. 4a shows a screenshot of the electronic device, when executing the application for height estimation. The processor may input the image to the first neural network after performing some pre-processing as explained above with reference to FIG. 2. As seen in FIG. 4a, the human (infant) is almost entirely visible in the image 401a. Only one hand is not visible. In addition, the keypoints of the heels, ankles, knees, hips, and shoulders, are visible for both the left and the right side. The first neural network will thus be able to identify all of the predefined keypoints. For example, if the first neural network is the BlazePose neural network, the 33 predefined keypoints will be identified. For embodiments of the present invention, only 13 of the 33 keypoints are relevant, which are right heel, left heel, right ankle, left ankle, right hip, left hip, left knee, right knee, right shoulder, left shoulder, top forehead, middle eyes, and nose.

As seen in FIG. 4a, the reference information, in this case a credit card sized object, is present in the image 401a, and is completely visible. The second neural network will thus be able to recognize the object and output the reference information related information, in this case, the pixel per metric ratio.

In FIG. 4b, the infant is entirely visible in the image 401b. Its legs are bent, so it is not in a straight position. However, because the relevant keypoints are visible, the first neural network will be able to identify the keypoints and the processor will be able to estimate the pixel height of the infant. The reference information is completely visible, so the second neural network will be able to recognize the object and output the reference information related information, in this case, the pixel per metric ratio.

In FIG. 4c, the infant is entirely visible in the image 401c, however, it is lying sideways with one knee bent. In this scenario, because not all of the keypoints are visible, the first neural network will not be able to identify the keypoints and the processor will not be able to estimate the pixel height of the infant. The reference information is completely visible, so the second neural network will be able to recognize the object and output the reference information related information, in this case, the pixel per metric ratio. The first neural network will output a notification, with the output first information, and the processor will use this information to output, via the output unit, a notification to the user. With this notification the user will know that the height cannot be estimated because the infant is not correctly visible, and the user will be able to capture another image.

In FIG. 4d, the infant is entirely visible in the image 401d, however, it is lying facing down. In this scenario, because not all of the keypoints are visible, the first neural network will not be able to identify the keypoints and the processor will not be able to estimate the pixel height of the infant. The reference information is completely visible, so the second neural network will be able to recognize the object and output the reference information related information, in this case, the pixel per metric ratio. The first neural network will output a notification, with the output first information, and the processor will use this information to output, via the output unit, a notification to the user. With this notification the user will know that the height cannot be estimated because the infant is not correctly visible, and the user will be able to capture another image.

In FIG. 4e, the reference information is entirely visible in the image 401e. However, the infant is not entirely visible in the image, as its ankles are not visible, and his left side is also not entirely visible. In this scenario, the first neural network will not be able to recognize enough keypoints to estimate the height. The first neural network will output a notification, as the output first information, and the processor will use this information to output, via the output unit, a notification to the user. With this notification the user will know that the height cannot be estimated because the infant is not correctly visible, and the user will be able to capture another image.

In FIG. 4f, the infant is entirely visible in the image 401f. However, there is no reference information. The second neural network will not be able to recognize any reference information, and will output a notification, as the output second information, and the processor will use this information to output, via the output unit, a notification to the user. With this notification the user will know that the height cannot be estimated because the reference information is not in the image, or not properly visible, and the user will be able to capture another image including the reference information, such as a reference object with a size of a credit card.

Although not represented in the drawings, it should be understood that other scenarios can occur in which at least one of the first or second neural network is not able to obtain the correct output information. For example, if the credit card sized object is only partially present but its size cannot be determined, the second neural network will output a notification.

In the foregoing description of the figures, the invention has been described with reference to specific embodiments thereof. It will, however, be evident that various modifications and changes may be made thereto without departing from the scope of the invention as summarized in the attached claims.

In particular, combinations of specific features of various aspects of the invention may be made. An aspect of the invention may be further advantageously enhanced by adding a feature that was described in relation to another aspect of the invention.

It is to be understood that the invention is limited by the annexed claims and its technical equivalents only. In this document and in its claims, the verb “to comprise” and its conjugations are used in their non-limiting sense to mean that items following the word are included, without excluding items not specifically mentioned. In addition, reference to an element by the indefinite article “a” or “an” does not exclude the possibility that more than one of the element is present, unless the context clearly requires that there be one and only one of the elements. The indefinite article “a” or “an” thus usually means “at least one”.

1. Electronic device for estimating a height of a human, the electronic device comprising:
a processor configured to:
obtain an image including at least a part of a representation of the human and reference information;
input the image to a first neural network and obtain as output from the first neural network first information, the first information related to a plurality of keypoints in the body of the human;
input the image to a second neural network and obtain as output from the second neural network second information, the second information related to the reference information; and
estimate the height of the human based on the first information and the second information; and
an output unit configured to output the estimated height.

2. The electronic device according to claim 1, wherein the second information is information linking the reference information with physical distance information.

3. The electronic device according to claim 1, wherein the first neural network is configured to segment the at least part of the representation of the human into a plurality of body parts, and to predict the plurality of keypoints in the body of the human based on the plurality of body parts.

4. The electronic device according to claim 3, wherein the information related to the plurality of keypoints comprises coordinate information about at least part of the plurality of keypoints.

5. The electronic device according to a wherein a keypoint corresponds to one of a list comprising face, shoulder, hip, knee, ankle and heel.

6. The electronic device according to claim 3, wherein the first neural network is configured to identify a predefined number of keypoints, and if at least one keypoint is not identified by the first neural network with at least 50% of detection confidence and at least 50% of visibility, the processor is configured to generate a notification indicating that the height cannot be estimated, and the output unit is configured to output the notification.

7. The electronic device according to claim 1, wherein the first neural network is a convolutional neural network for human pose estimation implemented with a BlazePose neural network, for which the prediction of the keypoints has been parametrized using mediapipe pose estimation application program interface, and wherein an output of the BlazePose/mediapipe pose solution application interface is passed through a Broyden, Fletcher, Goldfarb, and Shanno, BFGS, optimization algorithm.

8. The electronic device according to a claim 3, wherein the processor is further configured to use the first information to compute Euclidean distances between coordinates of the at least part of the plurality of keypoints on the image to calculate a pixel length of the representation of the human in the image.

9. The electronic device according to claim 1, wherein the reference information includes an object of a known predetermined size, such as an object of the size of a credit card.

10. The electronic device according to claim 9, wherein the second neural network is configured to find contours of the object, recognize the object, and obtain the predetermined size of the object, and wherein the second information comprises information related to the physical size of the object.

11. (canceled)

12. The electronic device according to claim 1, wherein the second neural network is formed from a convolutional neural network U-Net with EfficientNet-b0 backbone.

13. The electronic device according to claim 1, further comprising an image capturing unit configured to capture the image.

14. (canceled)

15. Method of obtaining the height of a human using the electronic device according to any one of the previous claims, the method comprising:
obtaining an image including at least a part of a representation of the human and reference information;
inputting the image to a first neural network, and obtaining as output from the first neural network first information, the first information related to a plurality of keypoints in the body of the human;
inputting the image to a second neural network and obtaining as output from the second neural network second information, the second information related to the reference information;
estimating the height of the human based on the first information and the second information, and
outputting the estimated height.

16. The method according to claim 15, wherein the operations of the first and second neural networks are performed by the processor of the electronic device.

17. The method according to claim 15, wherein the operations of the first and second neural networks are performed by a server in communication with the electronic device, and wherein the method further comprises the electronic device transmitting the image to the server and receiving the first information and the second information from the server.
